(19) United States
(12) Patent Application Publication
(10) Pub. No.: US 2017/0228503 A1
(43) Pub. Date: Aug. 10, 2017

(54) SYSTEM AND PROCESS FOR GENERATING A MEDICAL BILL

(71) Applicant: Justin Massengale, Brookline Village, MA (US)

(72) Inventor: Justin Massengale, Brookline Village, MA (US)

(21) Appl. No.: 15/428,209

(22) Filed: Feb. 9, 2017

Related U.S. Application Data
(60) Provisional application No. 62/293,234, filed on Feb. 9, 2016.

(51) Int. Cl. G06F 19/00; B42D 15/00; G06Q 90/00

(52) U.S. Cl. CPC G06F 19/328; G06Q 90/00; B42D 15/0053

(57) ABSTRACT

An ICD-10 paper coding system includes a first paper with a first table and a plurality of first cells which include clinical diagnostic terms. A second paper is attached to the first paper which has a corresponding second table with a plurality of second cells. The second cells contain terms corresponding to ICD-10 codes which relate to clinical diagnostic terms in the respective corresponding first cells. The tables have the same alignment such that when the first paper is placed over and aligned with the second paper, the first cells align with their corresponding second cells. The second paper can be carbon paper, such that when a clinical diagnostic term is marked on the first page, a reciprocal mark appears on a corresponding ICD-10 code on the second page.

### CROSS REFERENCE TO RELATED APPLICATION

This application is a U.S. non-provisional patent application which claims priority from U.S. Provisional application Patent No. 62/293,234 filed Feb. 9, 2016, which is incorporated herein by reference.

### FIELD OF THE INVENTION

The subject disclosure relates to healthcare and more particularly to improved generation of medical bills.

### BACKGROUND OF THE INVENTION

Medical billing depends on the selection of a diagnostic code for a patient visit with a provider in order for the provider to obtain payment reimbursement for that visit by a payor. These codes must be supported by the appropriate terminology in the medical records for that patient's visit, generated by the provider, to justify the code selected. Improper or inaccurate coding can result in charges which are not captured as well as underestimated patient illness severity and corresponding lack of justification for diagnostic tests and therapeutic interventions. Further, this can lead to the generation of query solicitations to providers from billers with the intent of clarifying omissions in the documentation and coding that providers submit before billing can be completed. These can, at best, consume providers' time in fixing and responding to these omissions. In other cases, it can result in lost revenue for practices and hospitals, or, in audit circumstances, imposed penalties for billing fraud. In addition, mandatory compliance with a worldwide change in the structure of the only approved coding system, the adoption of which was temporarily forestalled as part of the ObamaCare implementation in 2014, is now set to take effect. Adapting to the new coding system, termed ICD-10, requires a higher degree of specificity in documentation of the details of patients' medical conditions by providers in order to arrive at billable codes. Some diagnoses which formerly could be fully described with a mere handful of different codes may be represented by hundreds under the new structure.

Despite substantial time and financial investment in staff training and support being directed at readiness for these new requirements, a significant climate of uncertainty and apprehension pervades the health care community in anticipation of a period of unpredictably widespread reduction in revenue which will likely accompany the change, due to the industry's collective unfamiliarity with the new requirements. Office based physician practices presently depending on providers to circle applicable codes from a list on a billing sheet will find the volume of newly required codes far too vast to represent or select in this manner, risking the compromise of specificity and accuracy in code assignment for visits. The monetary impact of such compromises could exceed thousands of dollars daily in lost revenue for busy centers. To this end, it is crucial that a mechanism be placed in the hands of healthcare providers in office practices nationwide to both facilitate the accurate, complete, and consistent assignment of visiting billing codes, and to ensure the necessary clinical documentation of disease severity to justify their selection.

### SUMMARY OF THE INVENTION

The subject disclosure overcomes the drawbacks of the prior art by providing a system and method of quickly and reliably generating a medical bill.

The subject technology includes an ICD-10 paper coding system with a first paper. The first paper is of a first size having a first table formed from a plurality of first cells, each first cell corresponding to a clinical diagnostic term. The system includes a second paper of substantially the first size and attached to the first paper. The second paper has a second table formed from a plurality of second cells, each second cell corresponding to an ICD-10 code. The ICD-10 code is related to one of the clinical diagnostic terms. The first cells and the second cells have the same alignment on the first and second paper, respectively. Therefore, when the first paper is placed directly over the second paper, the first cells are vertically aligned with the plurality of second cells. Therefore when the first paper is placed directly over the second paper, the corresponding ICD-10 code of each second cell is aligned with the corresponding clinical diagnostic term of each first cell. In some embodiments, the second paper is carbon paper, such that when the first paper is placed directly over the second paper and a person writes on or marks the first paper, a reciprocal marking is created on the second paper.

The first table of the system may include a plurality or rows and columns each having a plurality of heads. The headings can be related to medical terminology that corresponds to the clinical diagnoses of the cells within that respective row or column. The medical terminology can be related to diseases or other categories related to conditions, healthcare diagnosis, and/or treatment. In some embodiments, the first paper is a first color and the second paper is a second color, the second color being different than the first color to denote that it is a copy or a billing sheet. The first and second papers may also include medical record stickers with identifying information about the patient and their visit.

The subject technology also relates to a method of generating a medical billing form which identifies the appropriate ICD-10 billing codes for billing treatment. The method starts once a patient receives treatment during a visit with a medical professional at a healthcare provider location and there is a need to generate a medical bill. First, a first page is generated. A second page is formed from copy paper. The first page has a first table formed from a plurality of first cells. The second page has a second table formed from a plurality of second cells, the second table being identical to the first table such that each of the second cells has a corresponding first cell. In some embodiments, the second page can be formed from carbon paper.

The first cells are filled in with clinical diagnostic terms. The second cells are filled in with ICD-10 billing codes, the ICD-10 billing code of each second cell being related the clinical diagnostic term of the corresponding first cell. The first and second page are then attached, such that when they are laid to rest on a substantially flat surface, the first page is aligned on top of the second page. The attached pages are then provided to a medical professional who has just met with a patient. The medical professional marks the first page, and the mark produces a reciprocal mark on the second page in a cell on the second page that corresponds to the cell that was marked on the first page. In this way, marking a clinical diagnostic term on the first page results in selecting an ICD-10 code on the second page. In some embodiments, the pages can then be separated and the second page sent to a billing company to obtain payment for the treatment of the patient.

In some embodiments, the first table of the first page also contains row headings and column headings. The headings align with the first cells and contain medical terminology related to the clinical diagnostic terms contained within the first cells with which they are aligned. This helps the medical professional identify the correct clinical diagnostic term, ensures accuracy of the diagnosis, and also provides key medical terminology that should be included in the patient's medical record, particularly as further support for the medical bill generated.

### BRIEF DESCRIPTION OF THE DRAWINGS

So that those having ordinary skill in the art to which the disclosed system pertains will more readily understand how to make and use the same, reference may be had to the following drawings.

FIG. 1 is a block diagram showing components of a system in accordance with the subject technology.

FIG. 2 is a flowchart showing a process in accordance with the subject technology.

### DETAILED DESCRIPTION OF PREFERRED EMBODIMENT

The subject technology overcomes many of the prior art problems associated with the generation of medical bills. The advantages, and other features of the systems and methods disclosed herein, will become more readily apparent to those having ordinary skill in the art from the following detailed description of certain preferred embodiments taken in conjunction with the drawings which set forth representative embodiments of the present invention.

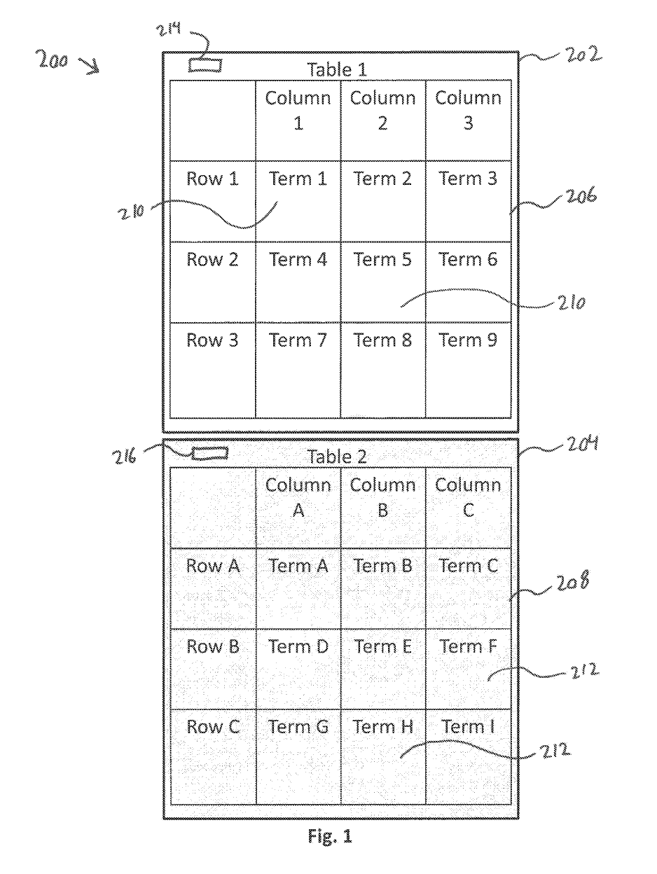

Referring now to FIG. 1, components of an ICD-10 paper coding system for generating a medical bill, in accordance with the subject technology, are shown generally at 200. In general, the components of the system 200 are employed after a patient visits a healthcare provider, such as a hospital, doctor's office, or the like. At the healthcare provider, the patient will meet with a medical professional, such as a doctor, to discuss their health and receive treatment. After the visit, the medical professional is tasked with filling out paperwork related to the visit and identifying ICD-10 codes for the treatment received by the patient. At this time, the medical professional uses the ICD-10 paper coding system of the subject technology.

The system includes a two-sheet table form which includes a first paper 202 and second paper 204. In general, the ICD-10 paper coding system automatically marks the correct ICD-10 code on the second paper 204, creating an ICD-10 billing sheet, after the medical professional selects a clinical diagnostic term on the first paper 202. For illustrative purposes, the first paper 202 and second paper 204 are shown detached from one another. However, before the system is employed, the second paper 204 is usually attached to the first paper 202, for example, by stapling or a paper clip. When attached, the first paper 202 is situated in front of, or on top of, the second paper 204. The papers 202, 204 are also generally aligned along their edges when attached.

After the patient visit, the treating medical professional is handed the attached first and second papers 202, 204. Each paper 202, 204 usually includes a sticker 214, 216 which has been affixed to the respective paper 202, 204 by members of the staff at that healthcare provider location. The stickers 214, 216 often contain relevant information for keeping medical records, including the patient's name, other identifying information, and the visit date.

Both the first and second papers 202, 204 have tables 206, 208. Each table 206, 208 is formed from a number of cells 210, 212. The first cells 210 of the first table 206 each correspond to a clinical diagnostic term, or term that a health care professional would use to label or classify a condition. For example, the first cells 210 themselves may include a series of terms related to a clinical diagnostic term (i.e. in the locations of Term 1, Term 2, etc.). Alternatively, or additionally, the table 206 may be set up as a series of rows and columns. The rows and columns have a series of row headings (i.e. Row 1, Row 2, etc.) and a series of column headings (i.e. Column 1, Column 2, etc.), respectively. The row and column headings work to allow the medical professional to locate the correct first cell 210 with the proper clinical diagnostic term. This can be done by including row and column headings of medical terminology that is related to the clinical diagnostic terms of the first cells 210 within that row or column. By way of simplified example, if the “Row 1” heading is “head trauma,” Terms 1, 2, and 3, may be clinical diagnostic terms related to head trauma. Similarly, the “Column 1” heading might be “nausea” and Terms 1, 4, and 7 would be clinical diagnostic terms related to nausea. In this case, the clinical diagnostic term “Term 1” might be “concussion” which relates to both “head trauma” and “nausea.” In other examples, the medical terminology of the headings might be related to other categories of medical terminology, such as diseases, in order to appropriately organize the clinical diagnostic terms and make selecting the correct terms easy for the medical professional.

Using headings not only helps the medical professional quickly identify a clinical diagnostic term, they serve as a reminder to the professional as to the basis from which the diagnosis is determined, because the headings use the same terms which are needed to support the diagnosis in medical documentation (i.e. patient medical records). The provider can then use these terms to confirm that they are included in the medical documentation of the visit. If the terms were omitted from the medical documentation, the provider can add a mention of them before the documentation is complete or create an addendum if the documentation has already been finalized.

As shown, the second table 208 of the second paper 204 is identical in size and shape to the first table 206 of the first paper 202 and both tables 206, 208 are aligned on their respective paper 202, 204 in like positions. This can be done by pre-printing the tables 206,208 onto their respective pages 202, 204 and/or by starting with a uniform standard blank table (which eventually gets filled in). Further, the first paper 202 and the second paper 204 are of a substantially similar size, such as a letter or legal paper size. Therefore when the first paper 202 is arranged directly on top of the second paper 204 with the edges being aligned, the first table 206 aligns with the second table 208. Therefore the cells 210 of the first table 206 align with cells 212 of the second table. The second paper 204 is usually a kind of copy paper, such as carbon paper, such that any marking on the first paper 202 is distinctly shown at a corresponding location on the second paper 204. Accordingly, the second paper 204 may be of a color (i.e. yellow) that is different from the color of the first paper 202 (i.e. white) to help denote that it is copy paper, or that the second paper 204 is a billing sheet as described in more detail herein.

The second cells 212 of the second table 208 correspond with ICD-10 codes. ICD-10 codes refer to a set of over 60,000 codes in the published International Classification of Diseases database which are used in medical billing. The particular ICD-10 code associated with each second cell 212 of the second table 208 also corresponds to the clinical diagnostic term in a first cell 210 from the first table 206 that would be aligned with that particular second cell 212 when the papers 202, 204 are aligned. For example, when the papers 202, 204 are aligned “Term 1” of the first paper would align with “Term A” of the second paper. Therefore the ICD-10 code associated with “Term A” would be the ICD-10 code for the clinical diagnosis identified by “Term 1.”

To use the system of the subject technology, the medical professional then takes the aligned papers 202, 204 and makes a marking for a clinical diagnostic term on the first paper 202, for example, by circling one of the clinical diagnostic terms within the first cells 210. Since the second paper 204 is copy paper, when the medical professional circles a first cell 210 on the first paper 202, the corresponding second cell 212 on the second paper 204 is also circled. For example, if “Term 1” were circled on the first paper 202, “Term A” would show as similarly circled on the second page 204. Therefore, since the first cells 210 of the first table 206 align with the second cells 212 of the second table 208 that have ICD-10 codes which correspond to the clinical diagnostic terms of the first cells 210, marking a clinical diagnostic term on the first page 202 results in an ICD-10 code being identified on the second page 204. It follows that as the medical professional fills out the first paper 202, a corresponding ICD-10 billing paper is created via the second paper 204 with ICD-10 codes being marked.

In light of the above, once the visit is over the medical professional is directed by the row and column headings of the first table 206 to the correct first cell 210 on the first page 202 that contains the diagnosis in text terms. The medical professional can then circle the relevant terms and tear off the second page 204. The second paper 204 can then be turned over to office staff for submission to the billing company, as the second paper 204 will contain accurate ICD-10 billing codes. This allows the medical professional to create an ICD-10 billing form for submission to a billing company without ever fighting to determine the correct ICD-10 billing code.

Notably, the second table 208 may also contain row headings (i.e. Row A, Row B, etc.) and column headings (i.e. Column A, Column B, etc.). However, in the example shown, the medical professional only needs rely on the row and column headings of the first table 206 as they only write directly on the first paper 202. However, in some cases, row and column headings on the second table 208 can be useful to double check for accuracy after the first table 206 has been filled in. Further, while three rows and columns are shown in each of the tables 206, 208, it should be noted that any number of rows and columns could be used, with the understanding that the same number of rows and columns should be used in both tables 206, 208 such that the cells 210, 212 align when the papers 202, 204 are aligned.

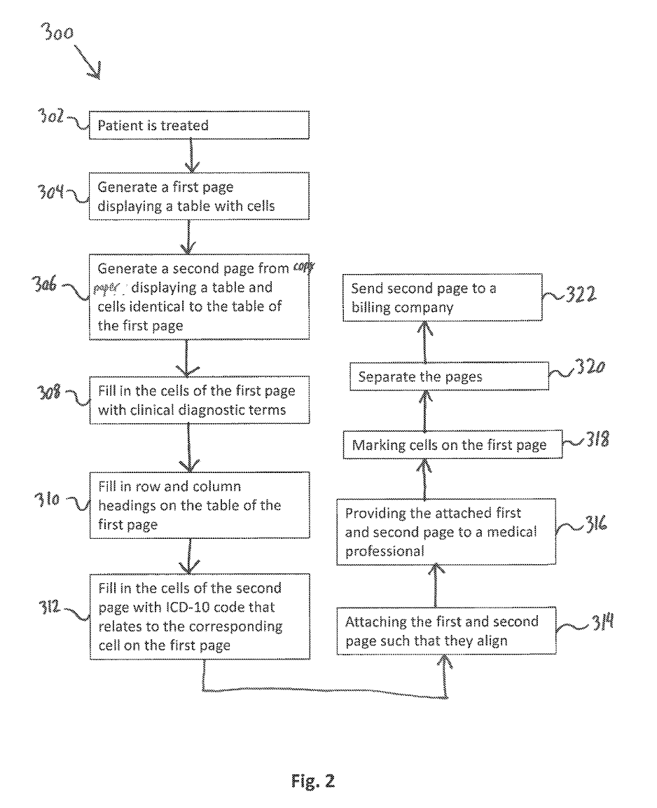

Referring now to FIG. 2, a block diagram of carrying out a process in accordance with the subject technology is shown generally at 300. The process 300 relates to billing for the treatment received by a patient after they visit with one or more medical professionals at a healthcare provider location. More specifically, the method generates a medical billing form for sending to a billing company that corresponds to a patient visit using ICD-10 billing codes. The ICD-10 codes displayed on the billing form are reliably related to the actual treatment that was received by the patient during their visit. Further, the ICD-10 codes on the billing form are designed to correspond to clinical diagnostic terms from the medical records that are generated based on that visit.

Therefore, at step 302, the patient receives medical treatment. This treatment can occur, for example, by one or more medical professionals at a healthcare provider location. Next, a number of steps are undergone which result in the creation of a two page form which will be filled out by the medical professional(s) who treated the patient in order to generate an accurate billing form.

At step 304, a first page is generated. The first page has a first table with a plurality of first cells. At step 306, a second page is generated from copy paper. The copy paper may be any material that produces a marking when a pressure is applied either directly to it or to an object situated above it. The second page includes a second table with a plurality of second cells, the second table being identical to the first table. Since the first table and the second table are identical, each cell of each table has a corresponding cell in the other table. Corresponding cells are aligned with one another when the first page and the second page are aligned (i.e. stacked on top of one another).

Next, at step 308, the first cells of the first table are filled in with clinical diagnostic terms related to patient treatment. The clinical diagnostic terms should relate to terms used by medical professionals to describe treatment of the patient, such that the medical professionals can find and mark a clinical diagnostic term that clearly relates to the treatment they provided a patient. In some cases, step 310 can be carried out as well. In step 310, a plurality of row headings and column headings are added to the first table. Each row and column heading is aligned with a number of rows and columns within the table of the first page. The headings display medical terminology that corresponds with the clinical diagnostic terms within the cells of the rows or columns with which that particular heading is aligned.

The second cells of the second table are then filled in with ICD-10 billing codes at step 312. The ICD-10 billing code of each second cell of the second table is determined based on the clinical diagnostic term of the corresponding first cell of the first table. Thus, once filled in, each second cell contains an ICD-10 billing code that is related to the clinical diagnostic term of the corresponding first cell. The first paper and second paper are then attached, at step 314, in such a way that when placed on a flat surface the first page is on top of and aligned (i.e. the edges substantially line up) with the second page. Since the first table and the second table were initially identical, this results in the tables aligning when the pages are placed down together. Additionally, when lying flat, it results in the first cells of the first table, aligning with the corresponding second cells of the second table.

At step 316, the attached forms are then provided to at least one of the medical professionals who just treated the patient during their visit. The medical professional, or someone under their direction, then places the attached papers on a substantially flat surface so that they can mark them. At step 318, the medical professional then marks the first cells that correspond with the correct clinical diagnostic terms for the treatment that was provided. If the first table includes row and column headings, the headings can help direct the medical professional to the correct first cells for marking. Since the second page is copy paper, such as carbon paper, and is situated directly behind and aligned with the first page, marking the first page results in a reciprocal mark appearing on the second page. The reciprocal mark on the second page will be located in the cell that corresponds with the cell marked on the first page. Since the second page cells include ICD-10 codes that correspond with the clinical diagnostic terms of the first page, the medical professional is able to identify an ICD-10 code for billing merely by marking a clinical diagnostic term on the first page.

After the first page is marked, at step 320, the medical professional or other office staff member separates the first page from the second page. Finally, at step 322, the second page, which contains the ICD-codes for billing, can be sent to a billing company to obtain payment for the treatment of the patient.

It will be appreciated by those of ordinary skill in the pertinent art that the functions of several elements may, in alternative embodiments, be carried out by fewer elements, or a single element. All processes shown and described herein, in different embodiments, may be carried out by executing the steps in a different order, or by omitting a step or adding additional steps.

While the subject technology has been described with respect to preferred embodiments, those skilled in the art will readily appreciate that various changes and/or modifications can be made to the subject technology without departing from the spirit or scope of the subject technology. For example, each claim may depend from any or all claims in a multiple dependent manner even though such has not been originally claimed.

1. An ICD-10 paper coding system comprising:
a first paper of a first size having a first table formed from a plurality of first cells, each first cell corresponding to a clinical diagnostic term; and
a second paper of substantially the first size and attached to the first paper, the second paper having a second table formed from a plurality of second cells, each second cell corresponding to an ICD-10 code, the ICD-10 code being related to one of the clinical diagnostic terms,
wherein the first cells and the second cells have the same alignment on the first and second paper, respectively, such that when the first paper is placed directly over the second paper, the plurality of first cells are vertically aligned with the plurality of second cells.

2. The system of claim 1 wherein when the first paper is placed directly over the second paper, the ICD-10 code of each second cell is aligned with the corresponding clinical diagnostic term of each first cell that is related to that ICD-10 code.

3. The system of claim 1 wherein the second paper is carbon paper, such that when the first paper is placed directly over the second paper, and a person can mark the first paper create a reciprocal mark on the second paper.

4. The system of claim 2 wherein:
the first table includes, a plurality of rows with a plurality of row headings and a plurality of columns with a plurality of column headings, each of the first cells located within one of the rows and one of the columns;
the row headings contain medical terminology that corresponds to the first cells situated within the row of that row heading; and
the column headings contain medical terminology that corresponds to the first cells situated within the column of that column heading.

5. The system of claim 2 wherein the first paper is a first color and the second paper is a second color, the second color being different than the first color.

6. The system of claim 2 wherein the medical terminology is related to diseases.

7. The system of claim 2 wherein each of the first and second papers contain a medical record sticker.

8. A method of generating a medical billing form which identifies the appropriate ICD-10 billing codes for billing for the treatment received by a patient during a visit with a medical professional at a healthcare provider location, the method comprising:
generating a first page and a second page formed from copy paper, the first page including a first table formed from a plurality of first cells and the second page including a second table formed from a plurality of second cells, the second table being identical to the first table such that each of the plurality of the second cells has a corresponding first cell;
filling in the first cells with clinical diagnostic terms;
filling in the second cells with ICD-10 billing codes, the ICD-10 billing code of each second cell being related the clinical diagnostic term of the corresponding first cell;
attaching the first page and the second page such that when placed on a flat surface, the first page is aligned with and on top of the second page;
providing the medical professional with the attached first and second pages; and
marking, by the medical professional, at least one first cell such that the copy paper of the second page produces a reciprocal mark on the second page at the second cell which corresponds with the marked first cell.

9. The method of claim 8 further comprising:
separating the first page from the second page; and
sending the second page to a billing company to obtain payment for the treatment of the patient.

10. The method of claim 9 further comprising:
adding a plurality of row headings and a plurality of column headings to the first table, the row headings and column headings each: aligned with a plurality of first cells; and containing a medical terminology related to the clinical diagnostic terms contained within the first cells with which they are aligned.

11. The method of claim 10 wherein the copy paper of the second page is carbon paper.
